(19) United States
(12) Patent Application Publication
(10) Pub. No.: US 2026/0320520 A1
(43) Pub. Date: Oct. 15, 2026

(54) System and method for blockchain-based resource prediction for web services

(71) Applicant: Bank of America Corporation, Charlotte, NC (US)

(72) Inventors: Manu Kurian, Dallas, TX (US); Vinesh Premji Patel, London (GB); Ana Maxim, Arlington, VA (US); Freddy A. Cabrera, Matthews, NC (US)

(21) Appl. No.: 19/175,566

(22) Filed: Apr. 10, 2025

(51) Int. Cl. G06Q 10/0631; G06N 20/00

(52) U.S. Cl. CPC G06Q 10/06315; G06N 20/00

(57) ABSTRACT

A system for blockchain-based resource prediction for web services. The system receives a job request and a plurality of tokens. The job request utilizes at least one of the plurality of tokens to perform an operation. The system executes an artificial intelligence (AI) algorithm using the plurality of tokens and the job request as an input to identify as first output a first group of tokens from the plurality of tokens to perform the job request. The system determines if the first group of tokens does not satisfy the threshold resource value at a second time period after the first time period. The system executes the AI algorithm using the plurality of tokens and the job request as a second input to predict as second output a second group of tokens utilized to perform the job request at the second time period.

### TECHNICAL FIELD

The present disclosure relates generally to predicting resources, and more specifically, to a system and method for blockchain-based resource prediction for web services.

### BACKGROUND

Avoiding downtime associated with a server device is a top priority for web services, especially when a server device is associated with critical web services such as flight services, weather services, cellular phone services, emergency services, streaming services, etc. However, a server device may fail to provide services because of several reasons, including, but not limited to, being unable to meet increased demand from user devices to access the server device. During such increased demand situations, server devices that provide web services may be unable to meet the increased demand because of resource constraints (e.g., limited processing speed of a server device) required to service a request. When the server device is unable to process requests associated with the increased demand due to resource constraints, then applications that are used to process those requests may halt operation, thereby causing bottlenecks in a network and wasting valuable processing resources and thus increasing downtime.

### SUMMARY

The disclosed system, described in the present disclosure, is particularly integrated into a practical application for predicting resources utilized to perform a job request associated with a web service. The disclosed system addresses technical problems rooted in network communications and achieves technical improvements to the network, the user devices, server devices, dynamic token monitoring device, and blockchain server devices used in network communications, and underlying computer systems that facilitate network communications between the user devices and server devices.

Conventional technologies are not configured to provide reliable web services between user devices and server devices. One of the technical challenges that may occur is an increase in the number of user devices requesting to access a web service provided by a server device. Since the server device has resource constraints (e.g., limited processing speed of a server device), the server device may be unable to meet the increased demand. When the server device is unable to process requests associated with the increased demand due to resource constraints, it may lead to several technical challenges. The technical challenges may include network congestion caused by increased demand that leads to data packets associated with job requests getting lost due to variable delays introduced by network congestion. Further, variable delays may result in delayed transmission of data packets. Delayed transmission of data packets causes delayed packet arrival times and out-of-order arrival of packets due to retransmission, which results in service interruptions of real-time applications (e.g., video streaming services).

Additionally, lost data packets may result in the jobs associated with a job request of a web service not being executed or completed. For example, the jobs associated with the job request may be batch-processing jobs to read and write data by connecting with a server device. When the data packets are lost, it results in a failure to execute the batch processing jobs. Further, certain other computing systems may rely on the batch processing jobs to be executed. In such a situation, since the batch processing jobs are not executed, this may result in system damage (e.g., compromised computing performance, device failure, etc.) to those other computing systems in communication with the server device. To remedy such harmful actions (i.e., system damage), the affected computing systems must be taken offline until the root problem is identified, thus making it inaccessible until the problem is identified and remedied. When a computing system is taken offline, it may further cause the computing systems to shut down or go offline and thus be unavailable to provide services. This results in, for example, under-utilization of the affected computing systems, resulting in reduced performance of the network. In a situation where multiple computing systems may go offline; it may result in disruption of network operations across the network. In some cases, the disruption of network operations across a network is often associated with unnecessary data redundancy and thus reduces the overall network performance. Further, multiple computing systems go out of service, which results in increased downtime that further generates inaccurate network resource usage patterns, which results in inaccurate network resource allocation.

Another technical challenge associated with a server device being unable to process requests associated with increased demand is network resource depletion because of increased network load. The network resource depletion increases network latency associated with performing, for example, jobs associated with a job request. These jobs may include, for example, voice calls, video calls, and data transmission (files, pictures, videos, etc.). This increase in network latency associated with jobs results in the slower processing of the job request, resulting in network traffic bottlenecks. Network traffic bottlenecks may result in the queuing of jobs in a jobs queue, which can have several negative effects on overall network performance. For example, when each operation in a jobs queue takes longer to complete due to high latency, the total time required to process all the jobs within the jobs queue increases. This directly affects the network's ability to process and exchange information efficiently, leading to slower overall system performance. Higher latency reduces throughput, which is the amount of data transmitted across the network in a given time period. This occurs because each job takes longer to complete, resulting in fewer tasks being processed in the same amount of time. Higher latency associated with performing the jobs also results in inefficient use of resources in the network. For example, high latency can lead to inefficient use of resources. For instance, when high latency delays the execution time of jobs, systems may remain idle while waiting for responses, leading to poor utilization of resources like CPU, memory, and bandwidth. In addition, when operations with high latency stack up or accumulate due to delays, they can create queues at intermediate network devices like routers, switches, and firewalls. This results in congestion of the network devices, thus lowering their performance.

In some embodiments, a system for blockchain-based resource prediction for web services includes a processor operably coupled to the memory and the memory configured to store one or more user profiles. The one or more user profiles includes a first user profile and wherein the first user profile includes a plurality of tokens. Each of the plurality of tokens represents a resource utilized to perform a job request. The processor is configured to electronically receive the job request including the plurality of tokens. The job request utilizes at least one of the plurality of tokens to perform an operation. The processor is further configured to execute an artificial intelligence (AI) algorithm using the job request including the plurality of tokens as an input to identify as first output a first group of tokens from the plurality of tokens to perform the job request. The AI algorithm is trained on a plurality of historical resources utilized to perform the job request. The first group of tokens includes at least a first token and a second token. The first group of tokens satisfies a threshold resource value associated with performing the operation. The processor is further configured to generate a first data block of a blockchain. The first data block includes the first token and the second token. The processor is further configured to execute the job request based on the first group of tokens at a first time period and determine if the first group of tokens does not satisfy the threshold resource value at a second time period after the first time period.

The processor is further configured to execute the AI algorithm using the job request including the plurality of tokens and as a second input to predict as second output a second group of tokens utilized to perform the job request at the second time period in response to determining the first group of tokens does not satisfy the threshold resource value. The second group of tokens includes the first token and a third token from the plurality of tokens to perform the job request. The processor is further configured to generate a second data block of the blockchain. The second data block includes the second group of tokens and dynamically executes the job request based on the second group of tokens at the second time period.

Thus, unlike conventional systems that are unable to provide reliable web services between user devices and server devices, the disclosed system determines if the first group of tokens does not satisfy the threshold resource value required to perform the job request. Upon determining the first group of tokens does not satisfy the threshold resource value, because of an increase in the number of user devices at the second server device, the processing speed of the second server device reduces. Since the processing speed of the second server device is reduced, this results in the first group of tokens not being able to satisfy the threshold resource value required to perform the job request. To prevent the above-explained technical challenges associated with an increase in the number of user devices utilizing the second server device, the system predicts a second group of tokens (i.e., a first token and a third token) to be utilized to perform the job request. The second group of tokens replaces the second token with a third token that provides sufficient processing speed (i.e., satisfies the threshold resource value) to perform the job request. The system dynamically executes the job request based on the second group of tokens.

Thus, by predicting a second group of tokens (i.e., a first token and a third token) to be utilized to perform a job associated with the job request, the above-explained technical challenges, such as loss of data packet, are prevented. The technical challenges associated with a lost data packet may include causing system damage to other computing systems in communication with the server device. When the data packets are lost, it results in a failure to execute the batch processing jobs. Further, certain other computing systems may rely on the batch processing jobs to be executed. In such a situation, since the batch processing jobs are not executed, this may result in system damage (e.g., compromised computing performance, device failure, etc.) to those other computing systems in communication with the server device. To remedy such harmful actions (i.e., system damage), the affected computing systems must be taken offline until the root problem is identified, thus making it inaccessible until the problem is identified and remedied. When a computing system is taken offline, it may further cause the computing systems to shut down or go offline and thus be unavailable to provide services. This leads to increased system downtime and further requires additional resources to remediate the offline computing systems, which in turn interrupts other operations that utilize the additional resources.

The second group of tokens replaces the second token with a third token that provides sufficient processing speed to perform the job request, this prevents loss of data packets associated with communicating with the second server device that has a reduced processing speed that is not able to satisfy the threshold resource value because of increased demand from user devices. Additionally, preventing data packets from being lost allows execution of the batch jobs associated with the web services, thereby reducing, or eliminating system damage. Further, latency in the transmission of data to user devices is reduced, and this results in the efficient servicing of job requests by reducing transmission delays. Additionally, reducing transmission delays avoids the out-of-order arrival of data packets due to retransmission, which in turn reduces service interruptions of real-time applications (e.g., video streaming services). Further, the system mitigates the above-described harmful actions that may otherwise occur to the other computing systems in communication with the server device, thus saving downtime associated with affected computing systems and additionally saving resources that would otherwise be necessary to remediate affected computing systems, which in turn provides uninterrupted operations of the network. This leads to improved operational efficiency of computing systems because the computing systems are not required to be taken offline for remediation.

Additionally, predicting a second group of tokens (i.e., a first token and a third token) to perform the job request reduces or avoids delays associated with communicating with the second server device that has a reduced processing speed, which results in the first group of tokens to not satisfy the threshold resource value. By utilizing the second group of tokens that replaces the second token with a third token which has sufficient processing speed (i.e., satisfies the threshold resource value) available to perform the job request, reduces the overall latency in the computing network. Lowering latency associated with performing operations associated with a web service in a computing network can significantly improve network performance and computing performance in several ways and result in several technical advantages. For example, lower latency means jobs are completed more quickly. This results in faster processing and data exchange across the network. Lower latency increases throughput of the network and user devices connected to the network. Since each job in a sequence takes less time to complete, more jobs can be processed in the same amount of time, resulting in higher throughput. With reduced latency, network and server resources are used more efficiently. Servers spend less time waiting for responses from other systems and can focus on processing jobs more rapidly, leading to better resource utilization. Lower latency also reduces the time spent waiting in queues for resources or data. This minimizes the chance of congestion or backlogs at network devices (e.g., routers, switches) or servers. As a result, data flows more freely through the network. In addition, reducing latency helps optimize bandwidth by allowing data to flow more efficiently. When jobs are completed more quickly, less bandwidth is wasted on waiting for data to be acknowledged or retransmitted, and the network can handle higher volumes of traffic.

Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of embodiments of the disclosure and the potential advantages thereof, reference is now made to the following written description taken in conjunction with the accompanying drawings, in which:

FIG. 1 is a schematic diagram of a system, in accordance with an embodiment of the present disclosure;

FIG. 2 illustrates an example blockchain including a chain of data blocks, in accordance with an embodiment of the present disclosure; and

FIG. 3 illustrates an example flowchart of a method of the system of FIG. 1 for blockchain-based resource prediction for web services.

### DETAILED DESCRIPTION OF THE DRAWINGS

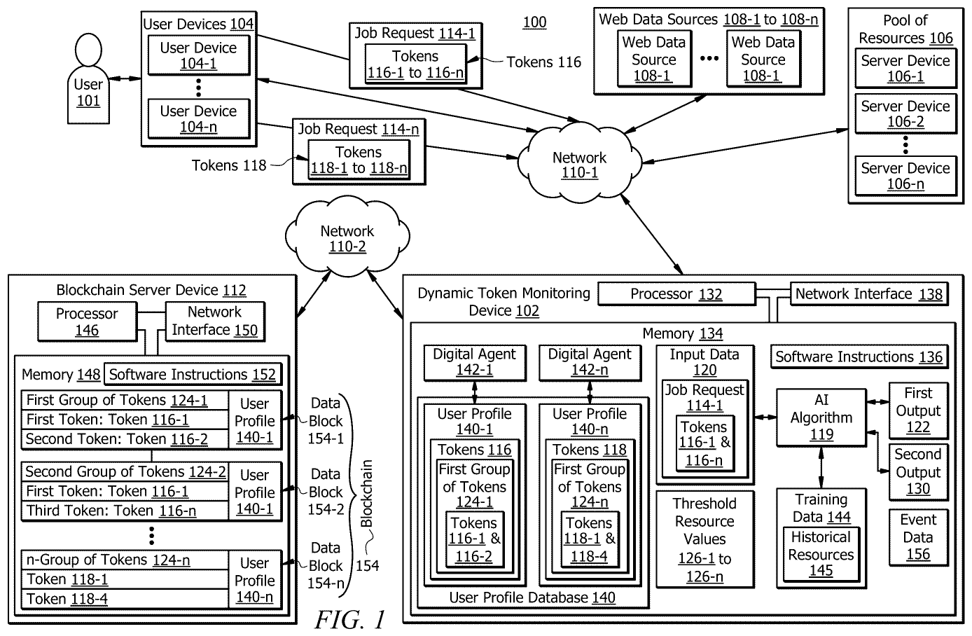

As described above, conventional technologies fail to provide reliable web services between user devices and server devices. Embodiments of the present disclosure and its advantages may be understood by referring to FIGS. 1-3. FIGS. 1-3 is used to describe systems and methods for blockchain-based resource prediction for web services, according to some embodiments.

### System Overview

FIG. 1 is a schematic diagram of a system 100, in accordance with certain aspects of the present disclosure. As shown, system 100 includes a dynamic token monitoring device 102, user devices 104, a pool of resources 106, and web data sources 108-1 to 108-n operably connected to one another and communicating via a network 110-1. Further, system 100 includes a blockchain server device 112 operably connected and communicating with the dynamic token monitoring device 102 via a network 110-2. In other embodiments, system 100 may include other elements instead of, or in addition to, those listed above. The user devices 104-1 to 104-n are collectively also referred to as user devices 104. The pool of resources 106 includes server devices 106-1 to 106-n. Although FIG. 1 shows a single blockchain server device 112, a plurality of different blockchain server devices 112 may also be included.

In general, the operations of system 100 are divided into two phases, i.e., a first phase and a second phase. In the first phase, a user 101 may interact with a software application installed on one of the user devices 104 (e.g., user device 104-1) to access a service (e.g., a web streaming service) provided by the pool of resources 106. In response to the interaction, the user device 104-1 generates a job request 114-1. The job request 114-1 includes a plurality of tokens 116-1 to 116-n. The plurality of tokens 116-1 to 116-n are collectively also referred to as the plurality of tokens 116. The plurality of tokens 116-1 to 116-n represents the resources utilized to perform the job request 114-1. For example, each of the plurality of tokens 116-1 to 116-n represents server devices 106-1 to 106-n utilized as resources to perform the job request 114-1. Specifically, token 116-1 represents the server device 106-1 with a first amount of processing speed, and similarly, token 116-2 represents the server device 106-2 with a second amount of processing speed, and token 116-n represents server device 106-n. This job request 114-1 is transmitted by the user device 104-1 to the dynamic token monitoring device 102. The dynamic token monitoring device 102 receives the job request 114-1 and executes the AI algorithm 119 using the job request 114-1, including the plurality of tokens 116, as input data 120. The AI algorithm 119 identifies a first group of tokens 124-1 as the first output 122 from the plurality of tokens 116 to perform the job request 114-1 at a first time period. The first group of tokens 124-1 includes token 116-1, which corresponds to the server device 106-1, and token 116-2, which corresponds to the server device 106-2. Upon identifying the first group of tokens 124-1 to perform the job request 114-1, the first phase ends.

In the second phase, the system 100 further determines if the first group of tokens 124-1 does not satisfy a threshold resource value 126-1 associated with the job request 114-1 at a second time period after a first time period. The threshold resource value 126-1 associated with the job request 114-1 may be the minimum amount of resources required to perform the job request 114-1. For example, threshold resource value 126-1 for the job request 114-1 is a minimum network bandwidth of 500 Mbps (Megabits per second) to perform the job request 114-1. System 100 may determine that the token 116-1, which corresponds to the server device 106-1, and the token 116-2, which corresponds to the server device 106-2, together, may only be able to provide a network bandwidth of 200 Mbps at a second time period. This may be because of an increase in the number of user devices 104 utilizing, for example, the server device 106-2 (i.e., token 116-2), the processing speed of the server device 106-2 reduces. Since the processing speed of the server device 106-2 reduces, this results in the first group of tokens to provide a reduced network bandwidth of, for example, 200 Mbps. Since, the first group of tokens 124-1 are not being able to satisfy the threshold resource value 126-1 required to perform the job request 114-1. The system 100 thus determines that the first group of tokens 124-1 are not able to satisfy the minimum processing speed of e.g., 500 Mbps to perform the job request 114-1 at the second time period.

To prevent the above-explained technical challenges associated with an increase in the number of user devices utilizing the server device 106-2, the system 100 executes AI algorithm 119 with the input data 120 to predict a second group of tokens 124-2 as a second output 130 to perform the job request 114-1 at the second time period. For example, the second group of tokens 124-2 includes the token 116-1, which corresponds to server device 106-1 with a first amount of processing speed, and the token 116-n corresponds to server device 106-n with a third amount of processing speed. The second group of token 124-2 replaces the token 116-2 with token 116-n. Token 116-n provides sufficient processing speed (i.e., satisfies the threshold resource value 126-1 of 500 Mbps) that would satisfy the threshold resource value 126-1 associated with the job request 114-1. The system dynamically executes the job request 114-1 by providing access to the requested service based on the second group of tokens 124-2.

### System Components

### User Device

System 100 includes user devices 104-1 to 104-n, these are collectively referred to as user device 104. The user devices 104-1 to 104-n may generally be any device configured to process data. User devices 104-1 to 104-n may also include but are not limited to, a personal computer, a desktop computer, a workstation, a server, a laptop, a tablet computer, a mobile phone (such as a smartphone), an Internet-of-Things (IoT) device, a wearable computing device, smart glasses, smart watches or bracelets, phablets, other smart devices, devices configured for wired or wireless RF (Radio Frequency) communication, or any other suitable type of device. The user devices 104-1 to 104-n may include a user interface, such as a display, a microphone, a camera, a keypad, or other appropriate equipment usable by a user. User devices 104-1 to 104-n may interact with an application installed on the user device 104-1 to access a service (e.g., a web streaming service) provided by the pool of resources 106. The applications installed on the user device 104 may be any web application utilized to access one or more services provided by the pool of resources 106.

### Pool of Resources

As shown in FIG. 1, the pool of resources 106 may include but is not limited to, server devices 106-1 to 106-n. The server devices 106-1 to 106-n may include, application server devices, web server devices, database servers, and file server devices, or any other server devices utilized to provide web services. The server devices 106-1 to 106-n are computers that are configured to provide one or more services in response to job requests 114-1 to 114-n received from user devices 104. The one or more services provided may include flight services, weather services, cellular phone services, emergency services, streaming services (audio/video streaming), voice calls, video calls, and/or data transmission (files, pictures, videos, etc.). Although any other web services may also be included. In some embodiments, the server devices 106-1 to 106-n may be implemented by a cluster of computing devices, such as virtual machines. For example, the server devices 106-1 to 106-n may be implemented by a plurality of computing devices using distributed computing and/or cloud computing systems in a network. In some embodiments, the server devices 106-1 to 106-n may be one or more servers in a server farm. In some embodiments, the server devices 106-1 to 106-n may include one or more servers in one or more data centers, data warehouses, and the like.

### Dynamic Token Monitoring Device

The dynamic token monitoring device 102 includes a processor 132 in signal communication with a memory 134. Memory 134 stores software instructions 136 that when executed by processor 132, cause processor 132 to perform one or more operations of the dynamic token monitoring device 102 described herein. The dynamic token monitoring device 102 further includes a network interface 138.

### Processor

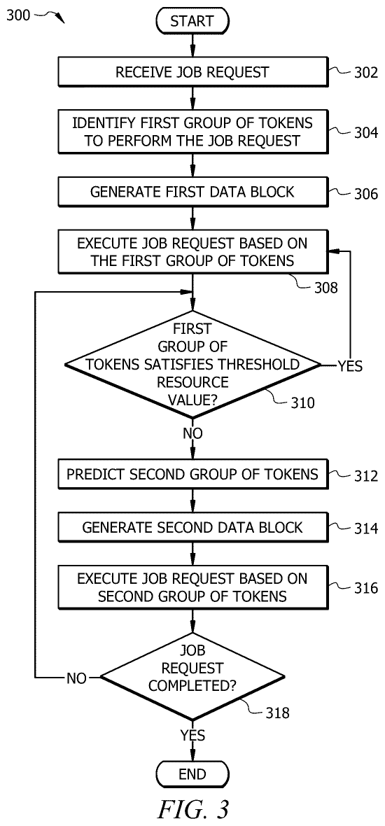

Processor 132 includes one or more processors. Processor 132 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors are configured to execute instructions (e.g., software instructions 136) to perform the operations of the dynamic token monitoring device 102 described herein. The processor 132 is configured to operate as described in FIGS. 1-3. For example, processor 132 may be configured to perform one or more operations of method 300 as described in FIG. 3.

### Network Interface

The network interface 138 may include an NFC interface, a Bluetooth® interface, a Zigbee® interface, a Z-wave® interface, a radio-frequency identification (RFID®) interface, a WIFI® interface, a local area network (LAN) interface, a wide area network (WAN) interface, a metropolitan area network (MAN) interface, a personal area network (PAN) interface, a wireless PAN (WPAN) interface, a modem, a switch, and/or a router. Network interface 138 is configured to enable wired and/or wireless communications. The network interface 138 may be configured to communicate data between the dynamic token monitoring device 102 and other devices, systems, or domains. The processor 132 may be configured to send and receive data using the network interface 138. The network interface 138 may be configured to use any suitable type of communication protocol.

### Memory

The memory 134 may be volatile or non-volatile and may comprise read-only memory (ROM), random-access memory (RAM), ternary content-addressable memory (TCAM), dynamic random-access memory (DRAM), and static random-access memory (SRAM). The memory 134 may include one or more of a local database, a cloud database, a network-attached storage (NAS), etc. The memory 134 comprises one or more disks, tape drives, or solid-state drives and may be used as an over-flow data storage device to store programs when such programs are selected for execution and to store instructions and data that are read during program execution. Memory 134 may store any of the information described in FIGS. 1-3 along with any other data, instructions, logic, rules, or code operable to implement the function(s) described herein when executed by processor 132. For example, the memory 134 may store the tokens 116-1 to 116-n, tokens 118-1 to 118-n, AI algorithm 119, input data 120, first output 122, second output 130, threshold resource values 126-1 to 126-n, software instructions 136, user profiles 140-1 to 140-n, digital agents 142-1 to 142-n, and/or any other data or instructions. The software instructions 136 may include any suitable set of instructions, logic, rules, or code operable to execute the processor 132 and perform the functions described herein, such as some or all of those described in FIGS. 1-3.

### Web Data Sources

Each of the web data sources 108-1 to 108-n represents any server device that stores websites accessible over the public Internet. By way of example, web data sources 108-1 to 108-n store information collected from websites that may include (i) news provider websites (such as, for example, Google News®, Yahoo! News®, CNN®, an Associated Press® feed, a Reuters® feed, etc.); (ii) a social networking site (such as, for example, Facebook®, Instagram®, Reddit®, Github®, Myspace®, LinkedIn® and/or Twitter®), although any other website may also be included. These websites provide information corresponding with the current and future events that may affect the operations of the pool of resources 106. Processor 132 is configured to access the web data sources 108-1 to 108-n and collect the current and future events data and store it as event data 156.

### Network 110-1

Network 110-1 may be any suitable type of wireless and/or wired network. The network 110-1 may be connected to the Internet or public network. Network 110-1 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., Wireless Fidelity (WiFi®), Wireless Gigabit (WiGig®), Worldwide Interoperability for Microwave Access (WiMAX®), etc.), a long-term evolution (LTE) network, a universal mobile telecommunications system (UMTS) network, a peer-to-peer (P2P) network, a Bluetooth® network, a near-field communication (NFC) network, and/or any other suitable network. The network 110-1 may be configured to support any suitable type of communication protocol, as would be appreciated by one of ordinary skills in the art. The dynamic token monitoring device 102, user devices 104, web data sources 108-1 to 108-n, and pool of resources 106 communicate with each other using the network 110-1.

### Blockchain Server Device

Blockchain server device 112 is generally any device that is configured to process data and communicate with the dynamic token monitoring device 102 of the system 100 via the network 110-2. The blockchain server device 112 comprises a processor 146 in signal communication with a memory 148 and a network interface 150. Processor 146 may comprise one or more processors operably coupled to the memory 148. Although FIG. 1 shows a single blockchain server device 112, a plurality of different blockchain server devices 112 may also be included. The blockchain server device 112 is configured to store, for example, data blocks 154-1 to 154-n. Each of the data blocks 154-1 to 154-n stores each of the individual groups of tokens 124-1 to 124-n corresponding with its respective user profiles 140-1 to 140-n. For example, data block 154-1 stores the first group of tokens 124-1 corresponding with user profile 140-1, data block 154-n stores the second group of tokens 124-2 corresponding with user profile 140-1, and data block 154-n stores n-group of tokens 124-n corresponding with user profile 140-n. The data blocks 154-1 to 154-n represent a blockchain 154.

Processor 146 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). Processor 146 may be a programmable logic device, a microcontroller, a microprocessor, or any suitable combination of the preceding. One or more processors are configured to process data and may be implemented in hardware or software. For example, processor 146 may be 8-bit, 16-bit, 32-bit, 64-bit, or of any other suitable architecture. Processor 146 is configured to implement various software instructions. For example, processor 146 is configured to execute software instructions 152 stored in memory 148 to perform the operations described herein.

Network interface 150 is configured to enable wired and/or wireless communications (e.g., via network 110-2). Network interface 150 is configured to communicate data between the dynamic token monitoring device 102 and other components of the system 100. For example, network interface 150 may comprise a WIFI interface, a local area network (LAN) interface, a wide area network (WAN) interface, a modem, a switch, or a router. Network interface 150 is configured to use any suitable type of communication protocol as would be appreciated by one of ordinary skill in the art.

Memory 148 may be volatile or non-volatile and may comprise a read-only memory (ROM), random-access memory (RAM), ternary content-addressable memory (TCAM), dynamic random-access memory (DRAM), and static random-access memory (SRAM). Memory 148 may be implemented using one or more disks, tape drives, solid-state drives, and/or the like. The memory 148 is operable to store software instructions 152 and/or any other data and instructions. Software instructions 152 may comprise any suitable set of software instructions, logic, rules, or code. The memory 148 is configured to receive the data blocks 154-1 to 154-n from dynamic token monitoring device 102 and store them as the blockchain 154.

### Network 110-2

Network 110-2 may be any suitable type of wireless and/or wired network. The network 110-2 may be connected to the Internet or public network. Network 110-2 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., Wireless Fidelity (WiFi®), Wireless Gigabit (WiGig®), Worldwide Interoperability for Microwave Access (WiMAX®), etc.), a long-term evolution (LTE) network, a universal mobile telecommunications system (UMTS) network, a peer-to-peer (P2P) network, a Bluetooth® network, a near-field communication (NFC) network, and/or any other suitable network. The network 110-2 may be configured to support any suitable type of communication protocol, as would be appreciated by one of ordinary skills in the art. The dynamic token monitoring device 102 and the blockchain server device 112 communicate with each other using the network 110-2.

### Initiate the First Phase

System 100 initiates the blockchain-based resource prediction for web services by performing operations in two phases. In the first phase, system 100 utilizes the AI algorithm 119 to determine a first group of tokens 124-1 from the plurality of tokens 116 to perform an operation associated with the job request 114-1, explained in detail below.

### Job Request Including the Tokens

In the first phase, one of the user devices 104 (e.g., user device 104-1) may interact with an application installed on the user device 104-1 to access a service (e.g., a web streaming service) provided by the pool of resources 106. In response to the interaction, the user device 104-1 generates a job request 114-1. The job request 114-1 includes a plurality of tokens 116-1 to 116-n. The plurality of tokens 116-1 to 116-n are collectively also referred to as the plurality of tokens 116. The plurality of tokens 116-1 to 116-n represents a resource of the pool of resources 106 utilized to perform the job request 114-1. For example, each of the plurality of tokens 116-1 to 116-n represents corresponding server devices 106-1 to 106-n utilized as a resource to perform the job request 114-1. Specifically, token 116-1 represents the server device 106-1 with a first amount of processing speed, token 116-2 represents the server device 106-2 with a first amount of processing speed, and similarly, token 116-n represents server device 106-n with a third amount of processing speed. In an embodiment, user device 104-n is able to transmit a job request 114-n to the dynamic token monitoring device 102.

### Receive the Job Request and Store Tokens in User Profiles

Processor 132 of dynamic token monitoring device 102 is configured to receive the job request 114-1 from the user device 104-1. The job request 114-1 includes tokens 116-1 and 116-n. Upon receiving the job request 114-1, processor 132 is configured to analyze the job request 114-1 and extracts the tokens 116 from the job request 114-1 by applying an extraction algorithm to the job request 114-1. For example, job request 114-1 may be a JavaScript Object Notation (JSON) format file and the extraction algorithm may be a JSON extraction algorithm. Upon extracting the tokens 116 from the job request 114-1, the processor 132 stores the tokens 116 in a user profile 140-1 and includes them in the user profile database 140.

In an embodiment, user device 104-n may transmit another job request (e.g., job request 114-n including tokens 118). The job request 114-n includes tokens 118-1 to 118-n and is a request to access a service provided by the pool of resources 106. The user profile database 140 stores a plurality of user profiles 140-1 to 140-n, such that each of the user profiles 140-1 to 140-n stores tokens (e.g., tokens 116 & tokens 118) associated with user devices 104-1 to 104-n. For example, user profile 140-1 stores tokens 116 associated with user device 104-1, and user profile 140-n stores tokens 118 associated with user device 104-n.

### Execute the AI Algorithm to Identify the First Group of Tokens

Processor 132 of dynamic token monitoring device 102 is configured to execute the AI algorithm 119 using the job request 114-1, including the plurality of tokens 116, as input data 120. The AI algorithm 119 is trained to identify as the first output 122 a first group of tokens 124-1 from the plurality of tokens 116 to perform the job request 114-1. The first group of tokens 124-1 includes token 116-1 which corresponds to the server device 106-1 and token 116-2 which corresponds to the server device 106-2. The first group of tokens 124-1 (i.e., tokens 116-1 and 116-2) are identified from the plurality of tokens 116 stored in the user profile 140-1.

The first group of tokens 124-1 is identified such that the execution of the job request 114-1, when performed, provides access to the service that the job request 114-1 intended to access at a required threshold resource value 126-1. The AI algorithm 119 is trained to identify, for example, server device 106-1 (i.e., token 116-1) that provides a first amount of processing speed utilized to perform at least a first portion of the job request 114-1 and the sever device 106-2 (i.e., token 116-2) second token that provides a second amount of processing speed utilized to perform at least a second portion of the job request 114-1. The first portion of the job request 114-1 and the second portion of the job request 114-1 together complete the job request 114-1. Thus, the AI algorithm 119 identifies (i.e., predicts) the first group of tokens 124-1 such that the execution of the job request 114-1, when performed, provides access to the service that the job request 114-1 intended to access at a required threshold resource value 126-1. For example, threshold resource value 126-1 indicates that job request 114-1 requires a minimum network bandwidth of, for example, 500 Mbps to perform the job request 114-1. Accordingly, the tokens 116-1 and 116-2 with the first amount of processing speed and the second amount of processing speed, respectively, are able provide the minimum network bandwidth of, for example, 500 Mbps to perform the job request 114-1. The memory 134 stores threshold resource values 126-1 to 126-n. These threshold resource values 126-1 to 126-n indicate a threshold amount of resources required to perform corresponding job requests 114-1 to 114-n.

### Train the AI Algorithm

The artificial intelligence (AI) algorithm 119 is trained using training data 144. The training data 144 includes two data sets. The first data set is collected based on past job requests processed over a past period of time. The first data set includes a plurality of historical resources 145 utilized to perform past job requests. The plurality of historical resources 145 provides information about which of the pool of resources 106 were utilized over a past period of time (e.g., one month, seven days, or any other time period) to perform past job requests. Annotations are applied to each of the plurality of historical resources 145 to create a modified set of plurality of historical resources. The annotations indicate if each of the plurality of historical resources 145 exceeds a corresponding threshold resource value (e.g., threshold resource values 126-1 to 126-n). Processor 132 creates a first training set which includes the first data set and the modified set of plurality of historical resources 145. The AI algorithm 119 is trained in a first stage using the first training set. Further, processor 132 creates a second training set for a second stage of training. The second training set includes the first training set and any incorrectly determined historical resources that exceed the corresponding threshold resource values. Processor 132 retrains the AI algorithm 119 in a second stage using the second training set to create a trained AI algorithm 119. The trained AI algorithm 119 is also referred to as AI algorithm 119.

The AI algorithm 119 is trained to identify (i.e., predict) the first group of tokens 124-1 such that the job request 114-1 is executed together by the server device 106-1 corresponding to token 116-1 and the server device 106-2 corresponding to token 116-2. Further, the execution of the job request 114-1 is performed such that user device 104-1 is able to access the service it intended to access as part of the job request 114-1 and at the required threshold resource value 126-1. For example, threshold resource value 126-1 indicates that job request 114-1 requires a minimum network bandwidth of, for example, 500 Mbps to perform the job request 114-1. Thus, the job request 114-1, when executed by the first group of tokens 124-1, the server device 106-1 and server device 106-2 provide the requested service to the user device 104-1 such that the service is provided at with a network bandwidth of, for example, 500 Mbps or more.

The AI algorithm 119 may include a support vector machine, machine learning, neural network, random forest, a large language model (LLM) algorithm, deep learning algorithm, k-means clustering, Tree-based algorithm, Random Forest algorithm, convolutional neural network (CNN), deep neural network (DNN), recurrent neural network (RNN), Naïve Bayes classification, etc. In some embodiments, the AI algorithm 119 may include a data processing machine learning algorithm. The AI algorithm 119 may be implemented by supervised, semi-supervised, and/or unsupervised machine learning. In another embodiment, processor 132 executes the AI algorithm 119 to identify as the first output 122 a first group of tokens 124-1 from the plurality of tokens 116 to perform the job request 114-1. In another embodiment, processor 132 executes software instructions 136 and is configured to identify as the first output 122 a first group of tokens 124-1 from the plurality of tokens 116 to perform the job request 114-1 without utilizing AI algorithm 119.

### Generate a First Data Block

Upon identifying the first group of tokens 124-1 to perform the job request 114-1, processor 132 of the dynamic token monitoring device 102 is configured to generate a data block 154-1. The data block 154-1 may include the first group of tokens 124-1 which includes the tokens 116-1 and 116-2, along with an identifier of the corresponding user profile 140-1 associated with the first group of tokens 124-1. Further, processor 132 is configured to store the data block 154-1 in the memory 148 of the blockchain server device 112. The data block 154-1 when stored in the memory 148 is stored as part of the blockchain 154.

The blockchain server device 112 is configured to store, for example, data blocks 154-1 to 154-n. Each of the data blocks 154-1 to 154-n stores each of the individual groups of tokens 124-1 to 124-n corresponding with its respective user profiles 140-1 to 140-n. For example, data block 154-1 stores the first group of tokens 124-1 corresponding with user profile 140-1, data block 154-n stores the second group of tokens 124-2 corresponding with user profile 140-1, and data block 154-n stores n-group of tokens 124-n corresponding with user profile 140-n. The data blocks 154-1 to 154-n represent a blockchain 154.

### Blockchain

The blockchain 154 includes blocks 154-1 to 154-n of linked data that are stored in an interconnected network of computers, with suitable stored programs at those computers to support ordered creation and transmission of the data blocks 154-1 to 154-n. The blockchain 154 forms a distributed database that maintains a continuously growing list of ordered records also termed as data blocks 154-1 to 154-n, that are timestamped and linked to a previous data block. Each of the data blocks 154-1 to 154-n in the series of blocks are linked together chronologically, with each new block containing a hash of the previous block. The order and place of each of the data blocks 154-1 to 154-n within the blockchain 154 may be determined by the hash associated with each of the previous blocks. By including a hash for each previous block of the data blocks 154-1 to 154-n, the blockchain 154 includes a chain of blocks 154-1 to 154-n from a genesis block 154-1 (or a block not shown above the block 154-1 in the example of FIG. 1) to the latest block 154-n (or a block not shown below the block 154-n in the example of FIG. 1). The blockchain server device 112 may store the entire record of linked data blocks 154-1 to 154-n. This creates a consensus network between the blockchain server device 112 and the dynamic token monitoring device 102 of to verify the integrity of each of the data blocks 154-1 to 154-n and the integrity of the entire blockchain 154. The consensus network has the benefit of having a high Byzantine fault tolerance, which is the ability of a computing system to tolerate Byzantine failures. As a result, blockchain 154 functions as a distributed database that ensures the integrity of the data by utilizing hash functions to link each block to its previous block and store the entire record of data blocks 154-1 to 154-n.

### Execute the Job Request

Processor 132 of the dynamic token monitoring device 102 is configured to execute the job request 114-1 based on the first group of tokens 124-1 at a first time period. The first time period is a timestamp of when the first group of tokens 124-1 are executed by the processor 132 to perform the job request 114-1. The job request 114-1 is executed together by the server device 106-1 corresponding to token 116-1 and the server device 106-2 corresponding to token 116-2. The execution of the job request 114-1 is performed such that user device 104-1 is able to access the service it intended to access as part of the job request 114-1 and at the required threshold resource value 126-1. For example, threshold resource value 126-1 indicates that job request 114-1 requires a minimum network bandwidth of 500 Mbps to perform the job request 114-1. Thus, the job request 114-1, when executed by the first group of tokens 124-1, the server device 106-1 and server device 106-2 provide the requested service to the user device 104-1 such that the service is provided at with a network bandwidth of 500 Mbps or more.

Upon executing the job request 114-1 based on the first group of tokens 124-1 at a first time period, the first phase ends.

### Initiate the Second Phase

In the second phase of operations of system 100, processor 132 of the dynamic token monitoring device 102 is configured to determine if the first group of tokens 124-1 satisfies a threshold resource value 126-1 associated with the job request 114-1 at a second time period after a first time period. When processor 132 determines that the first group of tokens 124-1 does not satisfy the threshold resource value 126-1, then processor 132 executes the AI algorithm 119 to determine a second group of tokens 124-2 from the plurality of tokens 116 that satisfy a threshold resource value 126-1 associated with the job request 114-1, explained in detail below.

### Determine If the First Group of Tokens Does Not Satisfy the Threshold Resource Value

Processor 132 of the dynamic token monitoring device 102 is configured to determine if the first group of tokens 124-1 satisfies a threshold resource value 126-1 associated with the job request 114-1 at a second time period after the first time period. The second time period may include 1 day, 1 week, 1 month, or any other time period after the first time period.

To determine if the first group of tokens 124-1 satisfies a threshold resource value 126-1, processor 132 determines the threshold resource value 126-1 associated with the job request 114-1. For example, threshold resource value 126-1 may be the minimum amount of resources required to perform the job request 114-1. For example, job request 114-1 requires a minimum network bandwidth of 500 Mbps to perform the job request 114-1. Upon processor 132 determines that the threshold resource value 126-1 is a minimum network bandwidth of 500 Mbps, processor 132 determines that the network bandwidth that token 116-1, which corresponds to the server device 106-1, and the token 116-2, which corresponds to the server device 106-2, together, provides to perform the job request 114-1 at the second time period. For example, processor 132 determines that first group of tokens 124-1 provides a maximum network bandwidth of 200 Mbps. This may be because of an increase in the number of user devices 104 utilizing, for example, the server device 106-2 (i.e., token 116-2), which results in the processing speed of the server device 106-2 being reduced. Since the processing speed of the server device, 106-2 reduces, this results in the first group of tokens providing a reduced network bandwidth of, for example, 200 Mbps at the second time period after the first time period. Processor 132 determines that at the second time period the first group of tokens 124-1 provides, for example, 200 Mbps, thus first group of tokens 124-1 does not satisfy the threshold resource value 126-1 (e.g., minimum network bandwidth of 500 Mbps) required to perform the job request 114-1. The processor 132 thus determines that the first group of tokens 124-1 are not able to satisfy the minimum processing speed of e.g., 500 Mbps to perform the job request 114-1 at the second time period.

### Execute the AI Algorithm to Predict the Second Group of Tokens

Processor 132 upon determining that the first group of tokens 124-1 does not satisfy the threshold resource value 126-1 required to perform the job request 114-1, the processor 132 executes AI algorithm 119 to predicts second group of tokens 124-2. By identifying the second group of tokens 124-2, processor 132 is configured to prevent the above-explained technical challenges associated with an increase in the number of user devices utilizing the server device 106-2.

Processor 132 executes the AI algorithm 119 by using the input data 120 including the job request 114-1 with the plurality of tokens 116 as a second input to the AI algorithm 119. The AI algorithm 119 predicts a second group of tokens 124-2 as a second output 130 to perform the job request 114-1 at the second time period. For example, the second group of tokens 124-2 includes the token 116-1, which corresponds to server device 106-1, and the token 116-n, which corresponds to server device 106-n. The second group of token 124-2 replaces the token 116-2 with token 116-n. Token 116-n provides sufficient processing speed (i.e., satisfies the threshold resource value 126-1 of 500 Mbps) that would satisfy the threshold resource value 126-1 associated with the job request 114-1. The token 116-n provides a third amount of processing speed utilized to perform at least the portion of the job request 114-1. The portion of the job request 114-1 performed by token 116-n is also referred to as a third portion of the job request 114-1. The first portion of the job request 114-1 (performed by token 116-1) and the third portion of the job request 114-1 (performed by token 116-n) together complete the job request 114-1. The system dynamically executes the job request 114-1 by providing access to the requested service based on the second group of tokens 124-2.

The second group of tokens 124-2 replaces the token 116-2 with token 116-3 that provides sufficient processing speed to perform the job request 114-1, this prevents loss of data packets associated with communicating with server device 106-2 that has a reduced processing speed that is not able to satisfy the threshold resource value 126-1 because of increased demand from user devices 104. Additionally, preventing data packets from being lost allows execution of the batch jobs associated with the web services, thereby reducing, or eliminating system damage. Further, latency in the transmission of data to user devices is lowered, and this results in the efficient servicing of job requests by reducing transmission delays. This significantly improves network performance and computing performance in several ways and results in several technical advantages. For example, lower latency means job requests are completed more quickly.

### Generate a Second Data Block

Upon identifying the second group of tokens 124-2 to perform the job request 114-1, processor 132 of the dynamic token monitoring device 102 is configured to generate a data block 154-2. The data block 154-2 may include the second group of tokens 124-2, which includes the tokens 116-1 and 116-n, along with an identifier of the corresponding user profile 140-1 associated with the second group of tokens 124-2. Further, processor 132 is configured to store the data block 154-2 in the memory 148 of the blockchain server device 112. The data block 154-2, when stored in the memory 148, is stored as part of the blockchain 154.

### Execute the Job Request in the Second Phase

Processor 132 of the dynamic token monitoring device 102 is configured to execute the job request 114-1 based on the second group of tokens 124-2 at a second time period. Processor 132 stops the execution of the job request 114-1 based on the first group of tokens 124-1 and then initiates execution of the job request 114-1 based on the second group of tokens 124-2. The job request 114-1 is executed together by the server device 106-1 corresponding to token 116-1 and the server device 106-n corresponding to token 116-n. The execution of the job request 114-1 is performed such that user device 104-1 is able to access the service it intended to access as part of the job request 114-1 and at the required threshold resource value 126-1. For example, threshold resource value 126-1 indicates that job request 114-1 requires a minimum network bandwidth of 500 Mbps to perform the job request 114-1. Thus, the job request 114-1, when executed by the second group of tokens 124-2, the server device 106-1 and server device 106-n provide the requested service to the user device 104-1 such that the service is provided at with a network bandwidth of 500 Mbps or more.

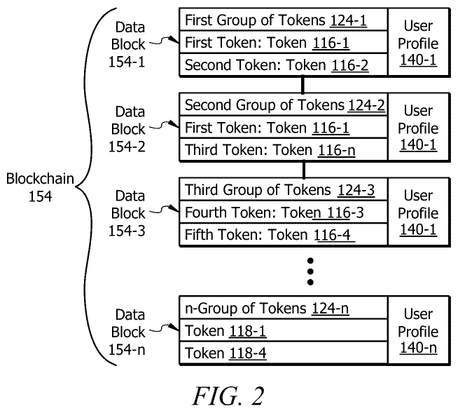

In an embodiment, processor 132 of the dynamic token monitoring device 102 is configured to determine if the second group of tokens 124-2 satisfies the threshold resource value 126-1 associated with job request 114-1 at a third time period after the second time period. In response to determining that the second group of tokens 124-2 does not satisfy the threshold resource value 126-1 associated with job request 114-1 at a third time period, processor 132, executes the AI algorithm 119 using the job request 114-1 including the plurality of tokens 116 as a third input to predict as third output a third group of tokens 124-3 (with reference to FIG. 2) utilized to perform the job request 114-1 at third time period. The third group of tokens 124-3 includes a fourth token 116-3 and a fifth token 116-4 from the plurality of tokens 116 to perform the job request 114-1. The third group of tokens 124-3 satisfies the threshold resource value 126-1 to perform the job request 114-1. Processor 132 then dynamically executes the job request 114-1 based on the third group of tokens 124-3 at the third time period. Further, the processor 132 generates a data block 154-3 and stores it in the blockchain 154.

Digital agents

In an embodiment, upon storing the plurality of tokens 116 in the user profile 140-1, processor 132 is configured to assign a digital agent 142-1 to the user profile 140-1. Similarly, processor 132 is configured to assign digital agents 142-1 to 142-n to each of the corresponding user profiles 140-1 to 140-n. For example, digital agent 142-1 is assigned to user profile 140-1, and digital agent 142-n is assigned to user profile 140-n. For example, digital agents 142-1 and 142-n are software programs with instructions that are configured to monitor the tokens (e.g., 116 and 118) included within the user profiles 140-1 and 140-n, respectively.

In an embodiment, processor 132 is configured to execute a digital agent 142-1 to determine if the first group of tokens 124-1 in the user profile 140-1 does not satisfy the threshold resource value 126-1 at a second time period after the first time period. Processor 132 executes digital agent 142-1 to monitor the plurality of tokens 166 in the first user profile 140-1 at a predetermined interval. The predetermined interval includes, for example, every 1 week, 1 day or 6 hours, or any other time interval may also be included. Digital agent 142-1, when executed, is configured to access event data 156 to determine if the first group of tokens 124-1 satisfies a threshold resource value 126-1 associated with the job request 114-1 at a second time period after a first time period. The event data 156 may be collected by processor 132 from the web data sources 108-1 to 108-n. The event data 156 may include, for example, a future sports event, a social event, or any other event may also be included. For example, the events included in the event data 156 may be scheduled at the second time period in the future, for example, after 1 day or 1 week or 1 month, or any other time period in the future after the first time period. For example, when the event data 156 indicates that the future sports event may require one of the pool of resources 106 (e.g., server device 106-2) to be utilized at an increased demand (i.e., increase in the number of user devices 104 accessing server device 106-2). Digital agent 142-1 is configured to analyze the event data 156 and determine, for example, at the second time period, server device 106-2 will have an increase in the number of user devices 104 accessing the server device 106-2 (i.e., token 116-2) to access the future sports event service provided by server device 106-2. This may result in the processing speed of the server device 106-2 to reduce. Since the processing speed of the server device, 106-2 reduces, this results in the first group of tokens providing a reduced network bandwidth of, for example, 200 Mbps at the second time period after the first time period. The digital agent 142-1 thus determines that the first group of tokens 124-1 are not able to satisfy the minimum processing speed of e.g., 500 Mbps to perform the job request 114-1 at the second time period.

In an embodiment, processor 132 is configured to receive a job request 114-1 from user device 104-1. In this embodiment, the job request 114-1 may be a loan application request placed by user 101 associated with the user device 104-1. The job request 114-1 includes a plurality of tokens 116 and a first threshold resource value 126-1, which is a threshold data value (L1) requested (e.g., a loan amount, for example, L1 is $250,000) as part of the loan application. The plurality of tokens 116 associated with the loan application may include token 116-1 which represents a data value (D1) associated with a physical resource (e.g., a home property, for example, D1 is $200,000 or any physical resource), token 116-2 which represents a data value (D2) associated with a movable resource (e.g., a vehicle, for example, D2 is $100,000 or any other movable resource), and token 116-n that represents a data value (D3) associated with cryptocurrency resource included in a crypto wallet (e.g., crypto assets may include a Bitcoin, for example, D3 is $70,000 or any other cryptocurrency resource).

In response to the dynamic token monitoring device 102 receiving the job request 114-1 (i.e., the loan application), executes the AI algorithm 119 with the job request 114-1 as input to identify as first output a first group of tokens 124-1 (i.e., including tokens 116-1 and 116-2) from the plurality of tokens 116 that satisfy the first threshold resource value 126-1 associated with the job request 114-1. The AI algorithm 119 is trained to identify the first group of tokens 124-1 from the plurality of tokens 116, such that D1+D2 satisfies (i.e., meet or exceed) the first threshold resource value 126-1 (L1), which is a threshold data value (e.g., $250,000). For example, the first group of tokens 124-1, including token 116-1 provides a data value D1 of $200,000, and token 116-2 provides a data value D2 of $100,000. Thus, the first group of tokens 124-1 together provide a combined data value of $300,000 that exceeds the first threshold resource value 126-1 (L1) (e.g., a loan amount of $250,000). Accordingly, processor 132 determines that the first group of tokens 124-1 satisfies the threshold resource value of 126-1 of $250,000.

Next, processor 132 generates a data block 154-1 including the first group of tokens 124-1 (i.e., tokens 116-1 and 116-2) and the corresponding identifier associated with the user profile 140-1. Further, processor 132 is configured to store the data block 154-1 in the memory 148 of the blockchain server device 112. The data block 154-1 when stored in the memory 148 is stored as part of the blockchain 154.

Next, processor 132 executes the job request 114-1 to approve the loan application based on the first group of tokens 124-1 that together provide a combined data value of $300,000 that exceeds the first threshold resource value 126-1 (e.g., a loan amount of $250,000) at a first time period.

Next, processor 132 is configured to determine if the first group of tokens 124-1 does not satisfy the threshold resource value 126-1 at a second time period after the first time period. For example, processor 132 is configured to determine if the threshold resource value 126-1 (i.e., a minimum loan amount of $250,000) is being continued to be provided at the second time period (i.e., after the first time period) by the first group of tokens 124-1 that provided a combined data value of $300,000 at the first time period.

Accordingly, processor 132 is configured to determine if the token 116-1 provided a data value of $200,000 (at the first time period) based on the physical resource if it continues to provide the data value of $200,000 at the second time period. Processor 132 determines if the data value associated with the physical resource has increased or decreased or remains the same at the second time period. For example, when processor 132 determines that the data value of $200,000 provided by token 116-1 remains the same at the second time period and further determines that the data value of $100,000 provided by token 116-2 associated with the movable resource at the first time period, has reduced to $25,000 at the second time period. Processor 132 determines that token 116-1 continues to provide the data value of $200,000 at the second time period and token 116-2 has reduced to $25,000 at the second time period. Accordingly, processor 132 determines that the combined data value provided by the first group of tokens 124-1 is reduced to $225,000, and thus, the first group of tokens 124-1 does not satisfy the threshold resource value 126-1 of $250,000 at a second time period after the first time period.

Next, processor 132 executes the AI algorithm 119 using the job request 114-1, including the plurality of tokens 116 and as a second input to predict as second output a second group of tokens 124-2 utilized to perform the job request 114-1 at the second time period. The second group of tokens 124-2 (i.e., including tokens 116-1 and 116-n). The AI algorithm 119 is configured to identify the token 116-n which has a data value of $70,000 at the second time period associated with the cryptocurrency resource along with the token 116-1 continues to provide the data value of $200,000 at the second time period. Thus, the second group of tokens 124-2 provides a combined data value D1+D3 of $270,000 that satisfies the first threshold resource value 126-1 of L1 which is $250,000 associated with the job request 114-1.

Next, processor 132 executes the job request 114-1 to by continuing to approve the loan application based on the second group of tokens 124-2 that together provide a combined data value of $270,000 that exceeds the first threshold resource value 126-1 (e.g., a loan amount of $250,000) at a second time period.

The processor then stores the second group of tokens 124-2 as a data block 154-2 in the blockchain.

FIG. 3 illustrates an example flowchart of method 300 for blockchain-based resource prediction for web services in accordance with an embodiment of the present disclosure. For example, one or more operations of method 300 may be implemented, at least in part, in the form of software instructions 136 of FIG. 1, stored on a tangible non-transitory machine-readable medium or a computer-readable medium (e.g., memory 134 of FIG. 1) that, when run by one or more processors (e.g., processor 132 of FIG. 1) may cause the one or more processors to perform operations of the method 300.

At operation 302, processor 132 is configured to receive the job request 114-1 from the user device 104-1. The job request 114-1 includes tokens 116-1 and 116-n.

At operation 304, processor 132 is configured to execute the AI algorithm 119 using the job request 114-1, including the plurality of tokens 116, as input data 120. The AI algorithm 119 is trained to identify as the first output 122 a first group of tokens 124-1 from the plurality of tokens 116 to perform the job request 114-1. The first group of tokens 124-1 includes token 116-1 which corresponds to the server device 106-1 and token 116-2 which corresponds to the server device 106-2.

At operation 306, processor 132 is configured to generate a data block 154-1. The data block 154-1 may include the first group of tokens 124-1 which includes the tokens 116-1 and 116-2, along with an identifier of the corresponding user profile 140-1 associated with the first group of tokens 124-1.

At operation 308, processor 132 is configured to execute the job request 114-1 based on the first group of tokens 124-1 at a first time period.

At operation 310, processor 132 is configured to determine if the first group of tokens 124-1 satisfies a threshold resource value 126-1 associated with the job request 114-1 at a second time period after the first time period. When processor 132 determines that the first group of tokens 124-1 satisfies the threshold resource value 126-1 required to perform the job request 114-1, then method 300 loops back to operation 308.

Back at operation 310, When processor 132 determines that the first group of tokens 124-1 does not satisfy the threshold resource value 126-1 required to perform the job request 114-1, the method 300 then proceeds to operation 312.

At operation 312, processor 132 is configured to execute the AI algorithm 119 by using the input data 120, including the job request 114-1, with the plurality of tokens 116 as a second input to the AI algorithm 119. The AI algorithm 119 predicts a second group of tokens 124-2 as a second output 130 to perform the job request 114-1 at the second time period.

At operation 314, processor 132 is configured to generate a data block 154-2. The data block 154-2 may include the second group of tokens 124-2, which includes the tokens 116-1 and 116-n, along with an identifier of the corresponding user profile 140-1 associated with the second group of tokens 124-2.

At operation 316, processor 132 is configured to dynamically execute the job request 114-1 based on the second group of tokens 124-2 at a second time period.

At operation 318, processor 132 is configured to determine if the execution of the job request 114-1 is completed. When processor 132 determines that the execution of the job request 114-1 is not completed, then the method 300 loops back to operation 310. Further, when processor 132 determines that the execution of the job request 114-1 is completed, then method 300 takes the Yes branch and the method 300 ends.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112(f), as it exists on the date of filing hereof, unless the words “means for” or “step for” are explicitly used in the particular claim.

What is claimed is:

1. A system comprising:
a memory operable to store one or more user profiles, wherein the one or more user profiles includes a first user profile and wherein the first user profile includes a plurality of tokens, wherein each of the plurality of tokens represents a resource utilized to perform a job request; and
a processor operably coupled to the memory and configured to:
electronically receive, from a user device, the job request including the plurality of tokens, wherein the job request utilizes at least one of the plurality of tokens to perform an operation;
execute an artificial intelligence (AI) algorithm using the job request including the plurality of tokens as an input to identify as first output a first group of tokens from the plurality of tokens to perform the job request, wherein:
the AI algorithm is trained on a plurality of historical resources utilized to perform the job request;
the first group of tokens includes at least a first token and a second token; and
the first group of tokens satisfies a threshold resource value associated with performing the operation;
generate a first data block of a blockchain, wherein the first data block includes the first token and the second token;
execute the job request based on the first group of tokens at a first time period;
determine if the first group of tokens does not satisfy the threshold resource value at a second time period after the first time period;
in response to determining the first group of tokens does not satisfy the threshold resource value, execute the AI algorithm using the job request including the plurality of tokens and as a second input to predict as second output a second group of tokens utilized to perform the job request at the second time period, wherein the second group of tokens includes the first token and a third token from the plurality of tokens to perform the job request;
generate a second data block of the blockchain, wherein the second data block includes the second group of tokens; and
dynamically execute the job request based on the second group of tokens at the second time period.

2. The system of claim 1, wherein the processor is further configured to:
collect a first data set including a plurality of historical resources utilized to perform one or more past job requests;
annotate each of the plurality of historical resources to create a modified set of plurality of historical resources, wherein the annotations indicate if each of the plurality of historical resources exceeds the threshold resource value;
create a first training set comprising the first data set and the modified set of plurality of historical resources;
train the AI algorithm in a first stage using the first training set;
create a second training set for a second stage of training, the second training set comprising the first training set and any incorrectly determined historical resources that exceed the threshold resource values; and
retrain the AI algorithm in a second stage using the second training set.

3. The system of claim 1, wherein the processor further configured to:
assign a first digital agent to a first user profile, wherein the first digital agent is configured to monitor the plurality of tokens in the first user profile at a predetermined interval; and
assign a second digital agent to a second user profile, wherein the second digital agent is configured to monitor a second plurality of tokens included in a second user profile at the predetermined interval.

4. The system of claim 1, wherein the processor is further configured to:
determine if the second group of tokens satisfies the threshold resource value at a third time period after the second time period;
in response to determining the second group of tokens does not satisfy the threshold resource value at the third time period, execute the AI algorithm using the plurality of tokens and the job request as a third input to predict as third output a third group of tokens utilized to perform the job request at third time period, wherein the third group of tokens includes a fourth token and a fifth token from the plurality of tokens to perform the job request, wherein the third group of tokens satisfies the threshold resource value; and
dynamically execute the job request based on the third group of tokens at the third time period.

5. The system of claim 1, wherein the first token comprises a first amount of processing speed of a first server device utilized to perform at least a first portion of the job request, and the second token comprises a second amount of processing speed of a second server device utilized to perform at least a second portion of the job request.

6. The system of claim 5, wherein the third token comprises a third amount of processing speed at a third server device utilized to perform at least a third portion of the job request.

7. The system of claim 1, wherein the second group of tokens includes the third token from the plurality of tokens to perform the job request.

8. A method comprising:
electronically receiving, from a user device, a job request including a plurality of tokens, wherein the job request utilizes at least one of the plurality of tokens to perform an operation;
executing an artificial intelligence (AI) algorithm using the job request including the plurality of tokens as an input to identify as first output a first group of tokens from the plurality of tokens to perform the job request, wherein:
the AI algorithm is trained on a plurality of historical resources utilized to perform the job request;
the first group of tokens includes at least a first token and a second token; and
the first group of tokens satisfies a threshold resource value associated with performing the operation;
generating a first data block of a blockchain, wherein the first data block includes the first token and the second token;
executing the job request based on the first group of tokens at a first time period;
determining if the first group of tokens does not satisfy the threshold resource value at a second time period after the first time period;
in response to determining the first group of tokens does not satisfy the threshold resource value, executing the AI algorithm using the job request including the plurality of tokens and as a second input to predict as second output a second group of tokens utilized to perform the job request at the second time period, wherein the second group of tokens includes the first token and a third token from the plurality of tokens to perform the job request;
generating a second data block of the blockchain, wherein the second data block includes the second group of tokens; and
dynamically executing the job request based on the second group of tokens at the second time period.

9. The method of claim 8, further comprising:
collecting a first data set including a plurality of historical resources utilized to perform one or more past job requests;
annotating each of the plurality of historical resources to create a modified set of plurality of historical resources, wherein the annotations indicate if each of the plurality of historical resources exceeds the threshold resource value;
creating a first training set comprising the first data set and the modified set of plurality of historical resources;
training the AI algorithm in a first stage using the first training set;
creating a second training set for a second stage of training, the second training set comprising the first training set and any incorrectly determined historical resources that exceed the threshold resource values; and
retraining the AI algorithm in a second stage using the second training set.

10. The method of claim 8, further comprising:
assigning a first digital agent to a first user profile, wherein the first digital agent is configured to monitor the plurality of tokens in the first user profile at a predetermined interval; and
assigning a second digital agent to a second user profile, wherein the second digital agent is configured to monitor a second plurality of tokens included in a second user profile at the predetermined interval.

11. The method of claim 8, further comprising:
determining if the second group of tokens satisfies the threshold resource value at a third time period after the second time period;
in response to determining the second group of tokens does not satisfy the threshold resource value at the third time period, executing the AI algorithm using the plurality of tokens and the job request as a third input to predict as third output a third group of tokens utilized to perform the job request at third time period, wherein the third group of tokens includes a fourth token and a fifth token from the plurality of tokens to perform the job request, wherein the third group of tokens satisfies the threshold resource value; and
dynamically executing the job request based on the third group of tokens at the third time period.

12. The method of claim 8, wherein the first token comprises a first amount of processing speed of a first server device utilized to perform at least a first portion of the job request, and the second token comprises a second amount of processing speed of a second server device utilized to perform at least a second portion of the job request.

13. The method of claim 12, wherein the third token comprises a third amount of processing speed at a third server device utilized to perform at least a third portion of the job request.

14. The method of claim 8, wherein the second group of tokens includes the third token from the plurality of tokens to perform the job request.

15. A non-transitory computer-readable medium storing instructions that, when executed by a processor, cause the processor to:
electronically receive, from a user device, a job request including a plurality of tokens, wherein the job request utilizes at least one of the plurality of tokens to perform an operation;
execute an artificial intelligence (AI) algorithm using the job request including the plurality of tokens as an input to identify as first output a first group of tokens from the plurality of tokens to perform the job request, wherein:
the AI algorithm is trained on a plurality of historical resources utilized to perform the job request;
the first group of tokens includes at least a first token and a second token; and
the first group of tokens satisfies a threshold resource value associated with performing the operation;
generate a first data block of a blockchain, wherein the first data block includes the first token and the second token;
execute the job request based on the first group of tokens at a first time period;
determine if the first group of tokens does not satisfy the threshold resource value at a second time period after the first time period;
in response to determining the first group of tokens does not satisfy the threshold resource value, execute the AI algorithm using the job request including the plurality of tokens and as a second input to predict as second output a second group of tokens utilized to perform the job request at the second time period, wherein the second group of tokens includes the first token and a third token from the plurality of tokens to perform the job request;
generate a second data block of the blockchain, wherein the second data block includes the second group of tokens; and
dynamically execute the job request based on the second group of tokens at the second time period.

16. The non-transitory computer-readable medium of claim 15, wherein the instructions further cause the processor to:
collect a first data set including a plurality of historical resources utilized to perform one or more past job requests;
annotate each of the plurality of historical resources to create a modified set of plurality of historical resources, wherein the annotations indicate if each of the plurality of historical resources exceeds the threshold resource value;
create a first training set comprising the first data set and the modified set of plurality of historical resources;
train the AI algorithm in a first stage using the first training set;
create a second training set for a second stage of training, the second training set comprising the first training set and any incorrectly determined historical resources that exceed the threshold resource values; and
retrain the AI algorithm in a second stage using the second training set.

17. The non-transitory computer-readable medium of claim 15, wherein the instructions further cause the processor to:
assign a first digital agent to a first user profile, wherein the first digital agent is configured to monitor the plurality of tokens in the first user profile at a predetermined interval; and
assign a second digital agent to a second user profile, wherein the second digital agent is configured to monitor a second plurality of tokens included in a second user profile at the predetermined interval.

18. The non-transitory computer-readable medium of claim 15, wherein the instructions further cause the processor to:
determine if the second group of tokens satisfies the threshold resource value at a third time period after the second time period;
in response to determining the second group of tokens does not satisfy the threshold resource value at the third time period, execute the AI algorithm using the plurality of tokens and the job request as a third input to predict as third output a third group of tokens utilized to perform the job request at third time period, wherein the third group of tokens includes a fourth token and a fifth token from the plurality of tokens to perform the job request, wherein the third group of tokens satisfies the threshold resource value; and
dynamically execute the job request based on the third group of tokens at the third time period.

19. The non-transitory computer-readable medium of claim 15, wherein the first token comprises a first amount of processing speed of a first server device utilized to perform at least a first portion of the job request and the second token comprises a second amount of processing speed of a second server device utilized to perform at least a second portion of the job request.

20. The non-transitory computer-readable medium of claim 19, wherein the third token comprises a third amount of processing speed at a third server device utilized to perform at least a third portion of the job request.
